(19) United States
(12) Patent Application Publication
(10) Pub. No.: US 2009/0038928 A1
(43) Pub. Date: Feb. 12, 2009

(54) SPRING LOADED CONTACT FOR ROTARY INTERFACE

(75) Inventors: Navin K. Patel, Mechanicsburg, PA (US); William D. Irwin, Elizabethtown, PA (US); Keith E. Miller, Manheim, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Middletown, PA (US)

(21) Appl. No.: 11/835,598

(22) Filed: Aug. 8, 2007

(51) Int. Cl. H01H 19/20

(52) U.S. Cl. 200/570

(57) ABSTRACT

An electrical contact member for use with a rotary interface within a connector assembly is provided. The electrical contact member includes a lower portion adapted to receive an electrical wire; and a laterally deflectable upper portion connected to or formed integrally with the lower portion. The upper portion further includes a first lateral extension arm having a first contact point formed at the tip thereof and a second lateral extension arm having a second contact point formed at the tip thereof.

### BACKGROUND OF THE INVENTION

The described invention relates in general to electrical connectors and contacts used with electronic equipment, and more specifically to electrical contact members for use with rotary interfaces or other challenging interfaces found within certain connector assemblies.

Certain electronic equipment such as surgical systems and devices frequently utilize connector assemblies for the purpose of connecting system or device components to one other. Depending on the design of the connector assembly and the various components thereof, establishing and maintaining reliable electrical connections may be challenging. Connector assemblies that include rotary interfaces or other uniquely shaped or configured mechanical or electrical interfaces may experience intermittent or inadequate electrical connections if the contacts used within the connector assembly must move or travel any significant distance within the assembly. While spring probes and other similar prior art devices may offer a partial or temporary solution, these device may ultimately prove to be inadequate for use in such connector assemblies. Thus, there is an ongoing need for a contact that offers consistent and reliable performance when incorporated into connector assemblies that include unique connection configurations or geometries.

### SUMMARY OF THE INVENTION

The following provides a summary of exemplary embodiments of the present invention. This summary is not an extensive overview and is not intended to identify key or critical aspects or elements of the present invention or to delineate its scope.

In accordance with one aspect of the present invention, an electrical contact system for a rotary interface within a connector assembly is provided. This system includes: (a) a first connector assembly housing, wherein the first housing further includes first electrically conductive ring mounted therein and a second electrically conductive ring disposed within the first contact ring; (b) a second connector assembly housing connectable to the first housing, wherein the second housing is adapted to receive at least two electrical contact members; (c) a first substantially Y-shaped electrical contact member mounted within the second housing, wherein the first contact member includes a lower portion connected to or formed integrally with an upper portion, wherein the upper portion includes at least two contact points, and wherein each of the contact points makes physical and electrical contact with a portion of the first electrically conductive ring when the housing portions are connected to one another; and (d) a second substantially Y-shaped electrical contact member mounted within the second housing, wherein the second contact member includes a lower portion connected to or formed integrally an upper portion, wherein the upper portion includes at least two contact points, and wherein each of the contact points makes physical and electrical contact with a portion of the second electrically conductive ring when the first and second housings are connected to one another.

In accordance with another aspect of the present invention, electrical contact members for use with a rotary interface within a connector assembly are provided. Each contact includes: (a) a lower portion; and (b) an upper portion connected to or formed integrally with the lower portion, wherein the upper portion further includes: (i) a first lateral extension arm having a first contact point formed at the tip thereof, and (ii) a second lateral extension arm having a second contact point formed at the tip thereof.

In yet another aspect of this invention, a method for making electrical connections at a rotary interface within a connector assembly is provided. This method includes: (a) providing a first connector assembly housing, wherein the first housing further includes first electrically conductive ring mounted therein and a second electrically conductive ring disposed within the first contact ring; (b) providing a second connector assembly housing, wherein the second housing is adapted to be connected to the first housing, and wherein the second housing further includes: (i) a first substantially Y-shaped electrical contact member mounted within the second housing, wherein the first contact member includes a lower portion connected to or formed integrally with an upper portion, wherein the upper portion includes at least two contact points, and (ii) a second substantially Y-shaped electrical contact member mounted within the second housing, wherein the second contact member includes a lower portion connected to or formed integrally an upper portion, wherein the upper portion includes at least two contact points; and (c) connecting the second housing to the first housing such that each of the contact points on the first electrical contact makes physical and electrical contact with a portion of the first electrically conductive ring, and each of the contact points on the second electrical contact makes physical and electrical contact with a portion of the second electrically conductive ring.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a partially exploded view of an exemplary embodiment of an electrical contact system for a rotary interface within a connector assembly in accordance with the present invention showing the first and second contacts positioned within the second connector assembly housing.

FIG. 2 is a partially exploded view of the system of FIG. 1 showing the outer and inner contact rings positioned above the first and second contacts.

FIG. 3 is a top view of the system of FIG. 1 showing the first and second contacts positioned within the second connector assembly housing as well as the relative positions of the contact rings within the first connector assembly (bottom view).

FIGS. 4a-d are top, top perspective, side, and front views of a first or outer electrical contact in accordance with the present invention showing the relative positions and geometries of the upper and lower portions of the contact.

FIGS. 5a-d are top, top perspective, side, and front views of a second or inner electrical contact in accordance with the present invention showing the relative positions and geometries of the upper and lower portions of the contact.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to electrical connectors and contacts used with electronic equipment. A first general embodiment of this invention provides an electrical contact system for a rotary interface within a connector assembly; a second general embodiment of this invention provides electrical contact members for use with a rotary interface within a connector assembly; and a third general embodiment of this invention provides a method for making electrical connections at a rotary interface within a connector assembly. With reference now to the Figures, one or more specific embodiments of this invention shall be described in greater detail.

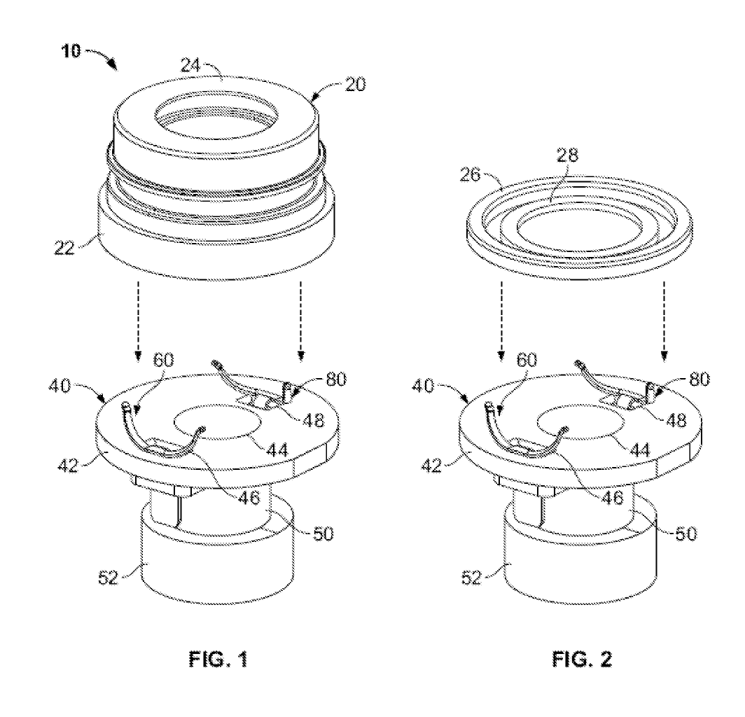

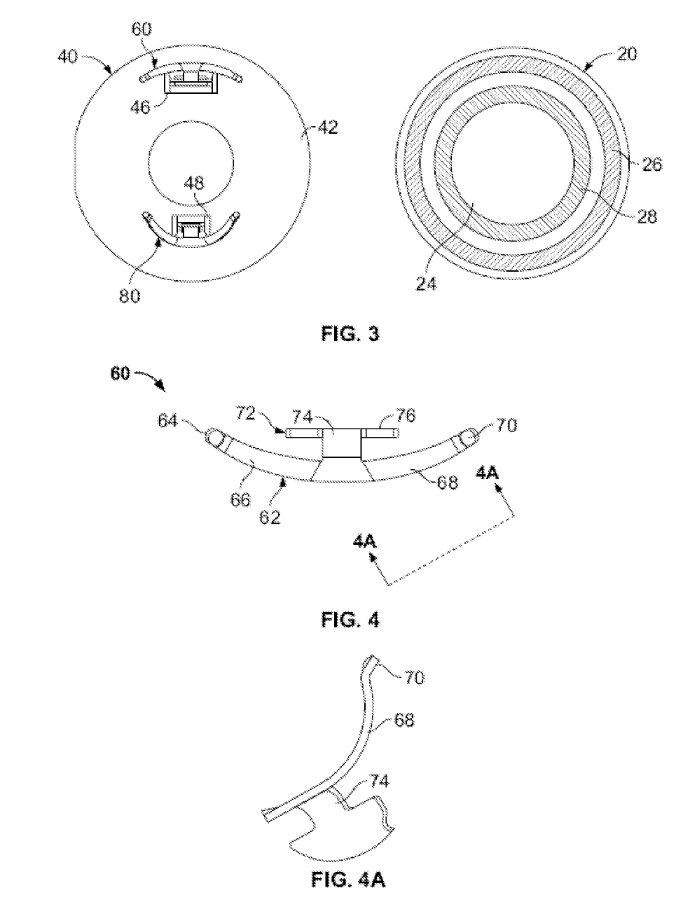

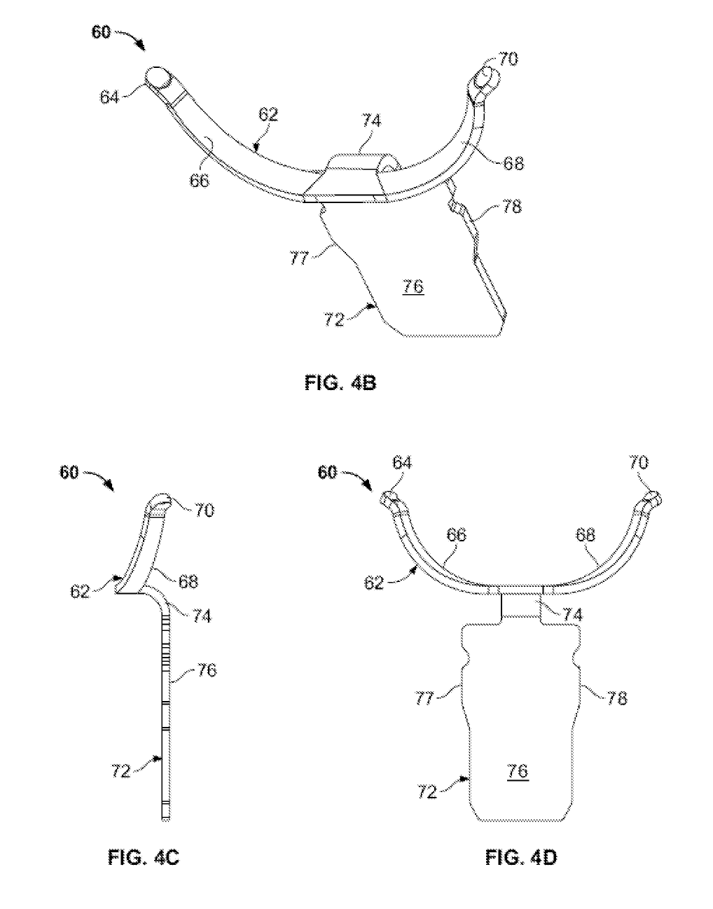

FIGS. 1-4a-d and 5a-d provide various views of an exemplary embodiment of the system of the present invention and the electrical contact members of the present invention. FIGS. 1 and 2 provide partially exploded perspective views of connector assembly 10, which in this embodiment includes a rotary interface between connector assembly components. As best shown in FIGS. 1-3, first connector assembly housing 20, which is the mating ring portion of connector assembly 10 includes a generally cylindrical body 22 having a centrally placed aperture 24, through which a threaded component connector rod (not shown) typically passes. Contained within housing 20 are two electrical contact rings that are concentrically arranged relative to one another. Electrical wires are terminated to these contact rings. Inner contact ring 28 is disposed within outer contact ring 26 (see FIGS. 2-3). Second connector assembly housing 40, which is the contact portion of connector assembly 10, includes crown 42, central aperture 44, outer contact slot 46, inner contact slot 48, stem 50 and pedestal 52. First and second contacts 60 and 80 respectively, are inserted into contact slots 46 and 48 and make physical and electrical contact with (i.e., are seated onto) outer contact ring 26 and inner contact ring 28 respectively when housings 20 and 40 are connected to one another.

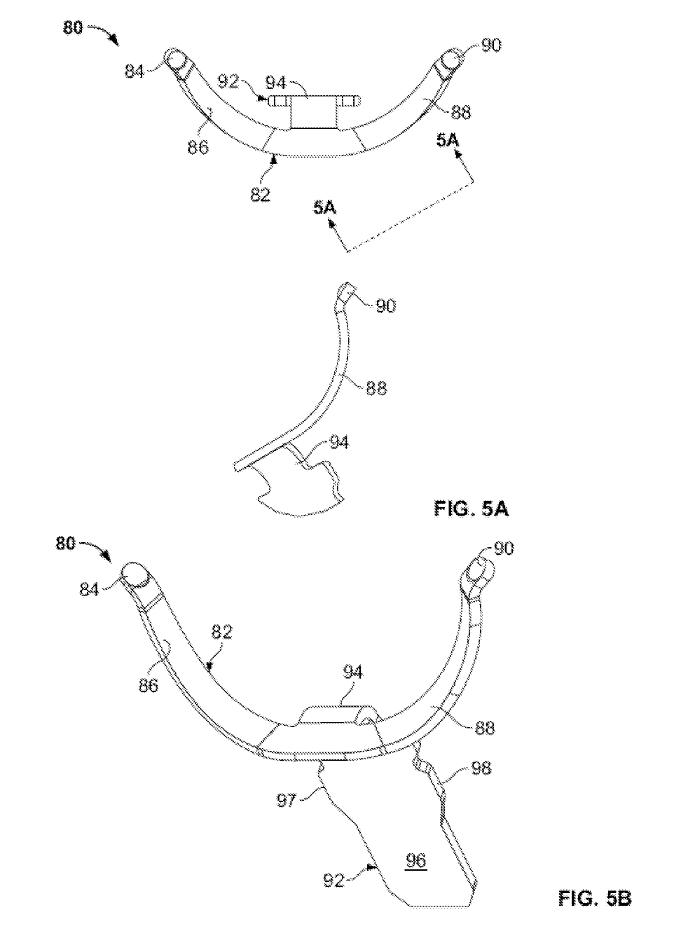

With reference to FIGS. 3 and 4a-d, first or outer contact 60 includes an upper portion 62 and a lower portion 72. Upper portion 62 is positioned perpendicular to lower portion 72 and is set slightly forward from lower portion 72 due to the forward curvature of stem 74 (see FIG. 4C). Upper portion 62 includes a first contact point 64 which is formed at the end of curved arm 66 and a second contact point 70, which is formed at the end of curved arm 68. Contact points 64 and 70 each include a slightly rounded upper surface that makes direct contact with outer ring 26 when housings 20 and 40 are connected to one another. As best shown in FIG. 4d, the ends of curved arms 66 and 68 are twisted slightly forward relative to the transverse axis of upper portion 62. This configuration provides a degree of biasing or spring-like behavior to upper portion 62. As downward pressure is applied to contact points 64 and 70, curved arms 66 and 68 flex slightly downward while still maintaining contact with outer ring 26. When such pressure is decreased or removed, curved arms 66 and 68 “spring” back to their neutral position again while still maintaining direct physical contact with outer ring 26. In this manner, first contact 60 permits a certain degree of travel between the components of the connector assembly while maintaining the integrity of the electrical interface therebetween. As best shown in FIG. 3, upper portion 62 is also curved (as viewed from above). This curvature combined with the twists in arms 66 and 68 create a deflection path for contact points 64 and 70 that follows the centerline of outer ring 26, thereby permitting deflection in a generally circular pattern without the need for geometric features in upper portion 62 that match the geometry of outer ring 26. As best shown in FIG. 4D, base portion 76 includes contoured surfaces 77 and 78 which are retention features for retaining the contact within second connector assembly housing 40.

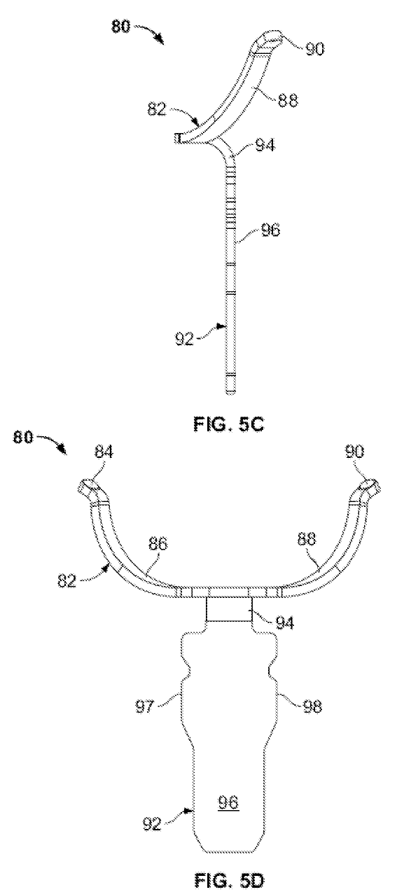

With reference to FIGS. 3 and 5a-d, second or inner contact 80 includes an upper portion 82 and a lower portion 92. Upper portion 82 is positioned perpendicular to lower portion 92 and is set slightly forward from lower portion 92 due to the forward curvature of stem 94 (see FIG. 5C). Upper portion 82 includes a first contact point 84 which is formed at the end of curved arm 86 and a second contact point 90, which is formed at the end of curved arm 88. Contact points 84 and 90 each include a slightly rounded upper surface that makes direct contact with inner ring 28 when housings 20 and 40 are connected to one another. As best shown in FIG. 5d, the ends of curved arms 86 and 88 are twisted slightly forward relative to the transverse axis of upper portion 82. This configuration provides a degree of biasing or spring-like behavior to upper portion 82. As downward pressure is applied to contact points 84 and 90, curved arms 86 and 88 flex slightly downward while still maintaining contact with inner ring 28. When such pressure is decreased or removed, curved arms 86 and 88 “spring” back to their neutral position again while still maintaining direct physical contact with inner ring 28. In this manner, second contact 80 permits a certain degree of travel between the components of the connector assembly while maintaining the integrity of the electrical interface therebetween. As best shown in FIG. 3, upper portion 82 is also curved (as viewed from above). This curvature combined with the twists in arms 86 and 88 create a deflection path for contact points 84 and 90 that follows the centerline of inner ring 28, thereby permitting deflection in a generally circular pattern without the need for geometric features in upper portion 82 that match the geometry of inner ring 28. As best shown in FIG. 5D, base portion 96 includes contoured surfaces 97 and 98 which are retention features for retaining the contact within second connector assembly housing 40. As shown in FIGS. 4D and 5D, base 76 is typically wider than base 96.

In one exemplary application, the spring-loaded Y-shaped electrical contacts of the present invention may be used to connect a handle or base portion to a functional or operative portion used for medical or surgical procedures. Systems of this nature typically include a mating ring connector that must make sufficient electrical contact with another connector that is axially aligned with the mating ring connector. The Y-shaped contacts of this invention can accommodate a relatively large amount of variation in the distance between the two connectors in the direction perpendicular to the axis and allow for rotation between connectors while still maintaining consistent electrical connection therebetween. The upper portions of each Y-shaped contact deflect to allow the contact points on the ends of the upper portions to follow the shaping of the mating ring regardless of the amount of deflection. In one example, electrical contact is maintained when the deflection experienced by the contact is 0.050 inches and the mating ring is only 0.014 inches wide. The described “twist” in each contact member facilitates maintaining the electrical contact.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. An electrical contact system for a rotary interface within a connector assembly, comprising:
(a) a first connector assembly housing, wherein the first housing further includes first electrically conductive ring mounted therein and a second electrically conductive ring disposed within the first contact ring;
(b) a second connector assembly housing connectable to the first housing, wherein the second housing is adapted to receive at least two electrical contact members;
(c) a first substantially Y-shaped electrical contact member mounted within the second housing, wherein the first contact member includes a lower portion connected to or formed integrally with an upper portion, wherein the upper portion includes at least two contact points, and wherein each of the contact points makes physical and electrical contact with a portion of the first electrically conductive ring when the housing portions are connected to one another; and
(d) a second substantially Y-shaped electrical contact member mounted within the second housing, wherein the second contact member includes a lower portion connected to or formed integrally an upper portion, wherein the upper portion includes at least two contact points, and wherein each of the contact points makes physical and electrical contact with a portion of the second electrically conductive ring when the first and second housings are connected to one another.

2. The electrical contact system of claim 1, further comprising a length of electrically conductive wire terminated to each of the electrically conductive rings.

3. The electrical contact system of claim 1, further comprising a length of electrically conductive wire terminated to the lower portion of each of the substantially Y-shaped contact members.

4. The electrical contact system of claim 1, wherein the first connector assembly housing and second connector assembly housing rotate axially relative to one another.

5. The electrical contact system of claim 1, wherein the upper portion of each substantially Y-shaped contact member is offset from and substantially perpendicular to the lower portion thereof.

6. The electrical contact system of claim 1, wherein the top portion of each substantially Y-shaped electrical contact member is at least partially deflectable in circular path.

7. An electrical contact member for use with a rotary interface within a connector assembly, comprising:
(a) a lower portion; and
(b) an upper portion connected to or formed integrally with the lower portion, wherein the upper portion further includes:
(i) a first lateral extension arm having a first contact point formed at the tip thereof; and
(ii) a second lateral extension arm having a second contact point formed at the tip thereof.

8. The electrical contact member of claim 7, wherein the contact member is substantially Y-shaped, and wherein the first extension arm extends away from the lower portion of the contact member in a direction opposite that of the second extension arm.

9. The electrical contact member of claim 7, wherein the first and second extension arms are laterally deflectable.

10. The electrical contact member of claim 7, wherein the upper portion of each contact member is offset from and substantially perpendicular to the lower portion thereof.

11. The electrical contact member of claim 7, wherein the lower portion of the contact member is adapted to receive the terminal end of an electrical wire.

12. The electrical contact member of claim 7, wherein the upper portion of each electrical contact member is configured in an arc for allowing the contact points to physically contact a ring structure at two separate points.

13. The electrical contact member of claim 7, wherein the electrical contact member is formed from a single piece of electrically conductive material.

14. A method for making electrical connections at a rotary interface within a connector assembly, comprising:
(a) providing a first connector assembly housing, wherein the first housing further includes first electrically conductive ring mounted therein and a second electrically conductive disposed within the first contact ring;
(b) providing a second connector assembly housing, wherein the second housing is adapted to be connected to the first housing, and wherein the second housing further includes:
(i) a first substantially Y-shaped electrical contact member mounted within the second housing, wherein the first contact member includes a lower portion connected to or formed integrally with an upper portion, wherein the upper portion includes at least two contact points, and
(ii) a second substantially Y-shaped electrical contact member mounted within the second housing, wherein the second contact member includes a lower portion connected to or formed integrally an upper portion, wherein the upper portion includes at least two contact points; and
(c) connecting the second housing to the first housing such that each of the contact points on the first electrical contact makes physical and electrical contact with a portion of the first electrically conductive ring, and each of the contact points on the second electrical contact makes physical and electrical contact with a portion of the second electrically conductive ring.

15. The method of claim 14, further comprising a length of electrically conductive wire terminated to each of the electrically conductive rings.

16. The method of claim 14, further comprising a length of electrically conductive wire terminated to the lower portion of each of the substantially Y-shaped contact members.

17. The method of claim 14, wherein the first connector assembly housing and second connector assembly housing rotate axially relative to one another.

18. The method of claim 14, wherein the upper portion of each substantially Y-shaped contact member is offset from and substantially perpendicular to the lower portion thereof.

19. The method of claim 14, wherein the top portion of each substantially Y-shaped electrical contact member is at least partially deflectable along a circular path.

20. The method of claim 14, wherein the upper portion of each electrical contact member is configured in an arc for allowing the contact points to physically contact a ring structure at two separate points.
